(19) United States
(12) Patent Application Publication
(10) Pub. No.: US 2026/0297884 A1
(43) Pub. Date: Oct. 1, 2026

(54) SMART MANHOLE COVER WITH RADAR LEVEL METER

(71) Applicant: BVK TEKNOLOJI ANONIM SIRKETI, Istanbul (TR)

(72) Inventors: Burak Berk USTUNDAG, Istanbul (TR); Serkan ERBORAL, Istanbul (TR); Yunus ATESMEN, Istanbul (TR)

(73) Assignee: BVK TEKNOLOJI ANONIM SIRKETI, Istanbul (TR)

(21) Appl. No.: 19/100,959

(22) PCT Filed: Aug. 3, 2023
(86) PCT No.: PCT/TR2023/050771

§ 371 Date: Feb. 4, 2025

(30) Foreign Application Priority Data
Aug. 4, 2022 (TR) 2022/012362

(51) Int. Cl. E02D 29/14; G01F 23/284; G01F 23/80; G01S 7/00; G01S 7/02; G01S 13/08; G01S 13/58; G01S 13/88; G06F 1/3206; H02J 7/35

(52) U.S. Cl. CPC E02D 29/14; G01F 23/284; G01F 23/804; G01S 7/003; G01S 7/027; G01S 13/08; G01S 13/58; G01S 13/882; G06F 1/3206; H02J 7/35; E02D 2600/10

(57) ABSTRACT

A device which is used in urban distribution and waste management networks such as sewerage, rainwater, waste collection, etc., without requiring an external wired power line, an external communication line or an external sensor connection, which can be activated in a plug-and-play manner, which can transfer safe and precise measurements with very low power consumption, and which can be used safely in forecasting, early warning, analysis, planning and management works by evaluating the change of data from other units it works with according to time and space.

### CROSS REFERENCE TO THE RELATED APPLICATION

This application is the national phase entry of International Application No. PCT/TR2023/050771, filed on Aug. 3, 2023, which is based upon and claims priority to Turkish Patent Applications No. 2022/012362, filed on Aug. 4, 2022, the entire contents of which are incorporated herein by reference

### TECHNICAL FIELD

The invention relates to a device which can be used in urban distribution and waste management networks such as sewerage, rainwater, waste collection, etc., without requiring an external wired power line, an external communication line or an external sensor connection, which can be activated in a plug-and-play manner, which can transfer safe and precise measurements with very low power consumption, and which can be used safely in forecasting, early warning, analysis, planning and management works by evaluating the change of data from other units it works with according to time and space.

The invention is an integrated device that provides information, observation and network management services based on machine learning by processing the measurement data based on the RADAR technique with a special algorithm with a multi-part antenna at V-band and above frequencies. It enables the liquid level in the networks such as waste water, rain water, etc. to be made through an integrated cover made of electrically insulating materials without the need to install a separate sensor, while exchanging data over the network. Thanks to its event-based task management system, it can function for many years without maintenance and safety with very low energy consumption.

### BACKGROUND

In cities, there are canals used for the discharge of fluids such as wastewater and rainwater, as well as networks that provide cable and material distribution. Many of these are usually served by manhole covers on roads and pavements. It is an old idea to obtain information about networks by measuring the level of manhole covers. The inventive device analyses the raw measurement data from the mm-wavelength RADAR module with V-Band and above frequencies with a low-power signal processing circuit and provides important operational advantages and innovative services with high reliability due to data transfer to a standard data collection network of LPWAN (Low-Power Wide-Area-Network) type. Traditional metal manhole covers are increasingly being replaced by composite covers. In the inventive device, the placement of the circuits in composite covers reduces losses in radio frequency (RF) communication and facilitates the fulfilment of RADAR and sensor functions. Due to its low power consumption, the inventive device can be installed by pairing with a planned point of the grid through a centralized system without the need for an external line connection and enables to fulfil many functions required for smart city management together. These functions include flood and overflow forecasting, risk management, inventory security, anomaly detection, object detection, access authorization, unauthorized access or damage detection, fault detection, predictive maintenance management, overcapacity prediction, leak detection and planning at a selected point of the network or regionally within the city. For this purpose, there have been commercial and academic trials of many kinds, including ultrasonic level measurement, optical measurement and RADAR technique measurement at lower frequencies. For the first time among these solutions, the device of the invention provides high resistance to external conditions by integrating into composite covers, can be activated by pairing itself via LPWAN data communication or a bluetooth connected mobile phone without requiring any external connection, can operate for a long time with high accuracy, without the need for maintenance or battery replacement, and can generate event type classified data with high accuracy by separately evaluating disturbing and external objects. In the device of the invention, data from the devices on the network are evaluated based on machine learning on the server and event detection and predictions at the network level are provided.

The patent numbered US20110148631A1 titled “Manhole Security Cover” and published on 23 Jun. 2011 provides the monitoring of unauthorized opening and closing of the manhole cover with radio frequency communication. In the present invention, without an external power line connection, the distance changes under the manhole cover are evaluated with the RADAR inside the manhole cover and manhole cover movements can also be detected with a very low power consuming circuit.

CN103761880A numbered patent titled “Urban traffic flow monitoring system based on on manhole cover”, published on 30 Apr. 2014, enables the detection of vehicles passing over it with a sensor on the manhole cover and sending it to a monitoring centre via radio frequency communication. The invention herein differs from the present invention both in the mechanism of the receiving sensor and in its mode of operation. In the invention CN103761880A, the infrared reflection detection technique is used since the priority is to count the vehicles passing over it. In the present invention, mm wavelength radar is used, especially since the level change under the manhole cover is monitored. In the present invention, if desired, the antenna directions can be multiplexed and motion and speed can be detected in both directions (up and down from the manhole cover). In addition, in the present invention, one of the LPWA (Low Power Wide Area) techniques, including the NB-IoT standard, is used to provide very low power consumption and wide area data transfer with commercial communication networks.

Starting from the patent numbered U.S. Pat. No. 4,116,061A “Sewer line analyzer probe” dated 26 Sep. 1978, there are inventions on analysis and warning based on level measurement in systems such as sewers or rainwater collection channels. The main difference of the inventions in this group from the device of the invention is that the device of the invention provides continuous, contactless and secure monitoring, control and management without external energy connection, which is achieved by using mm wavelength measurement and LPWAN communication together in a non-conductive manhole cover. Millimetre wavelength radar technique has been used for level measurements for different purposes in the past. However, for the first time, especially with the RADAR module in the V-Band and above frequencies, the change pattern of the distance in different time windows can be observed and with the LPWAN communication module, the possibility of managing urban channel systems with plug & play devices without external connection has been created with the inventive device.

### Object of Invention

The object of the present invention is to realise a device that can be used in urban distribution and waste management networks such as sewerage, rainwater, waste collection, etc., without requiring an external wired power line, an external communication line or an external sensor connection, that can be activated in a plug-and-play manner, that can transfer safe and precise measurements with very low power consumption, and that can be used safely in forecasting, early warning, analysis, planning and management works by evaluating the change of data from other units it works with according to time and space.

### BRIEF DESCRIPTION OF THE DRAWINGS

The device for achieving the objects of the present invention is shown in the attached figures, which figures:

FIG. 1 is a view of the physical layout and communication model of the inventive device in network monitoring.

FIG. 2 is a view of the cover and housing components of the inventive device.

FIG. 3 is a view of the antenna and optional solar panel connection in the device according to the invention.

FIG. 4 is a perspective view of the device of the invention with authorization control.

FIG. 5 is a cross-sectional view of an embodiment of the inventive device.

FIG. 6 is a view of the electronic circuit block diagram of the inventive device.

FIG. 7 is a view of the typical distance-amplitude measurement pattern of the inventive device after RADAR module pre-processing.

FIG. 8 is a view of the signal processing block diagram for level measurement in the inventive device.

FIG. 9 is a view of the multi-point inventive device operation example in the observed network.

FIG. 10 is a view of current event matching and future event prediction by machine learning from multi-point inventive device time series data.

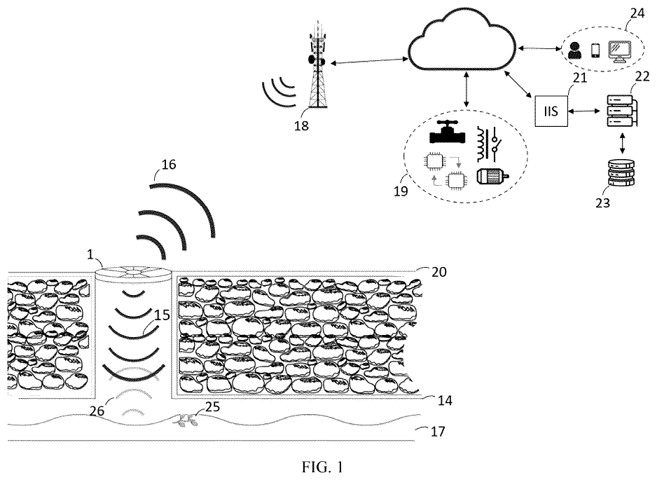

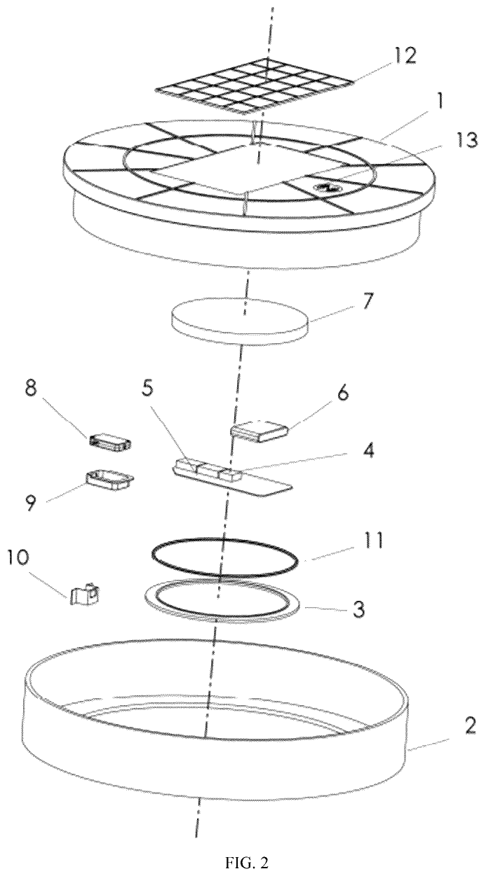

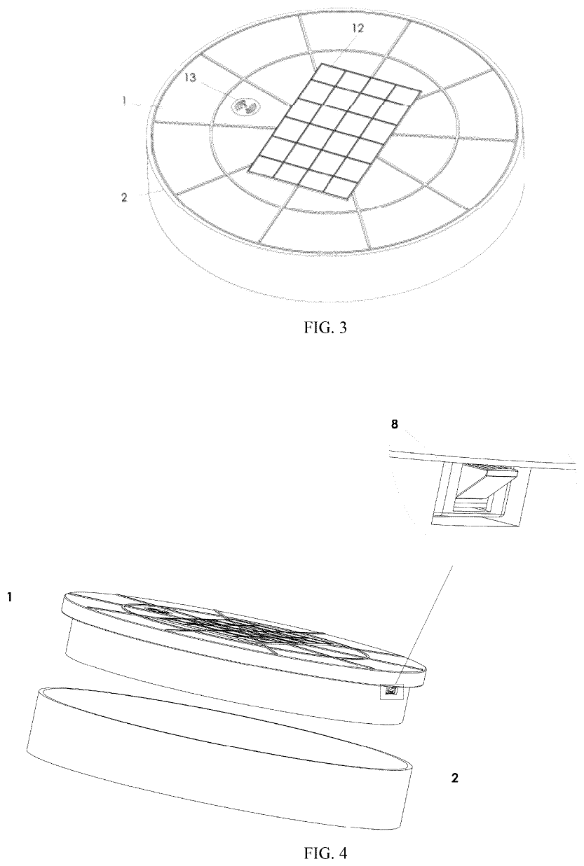

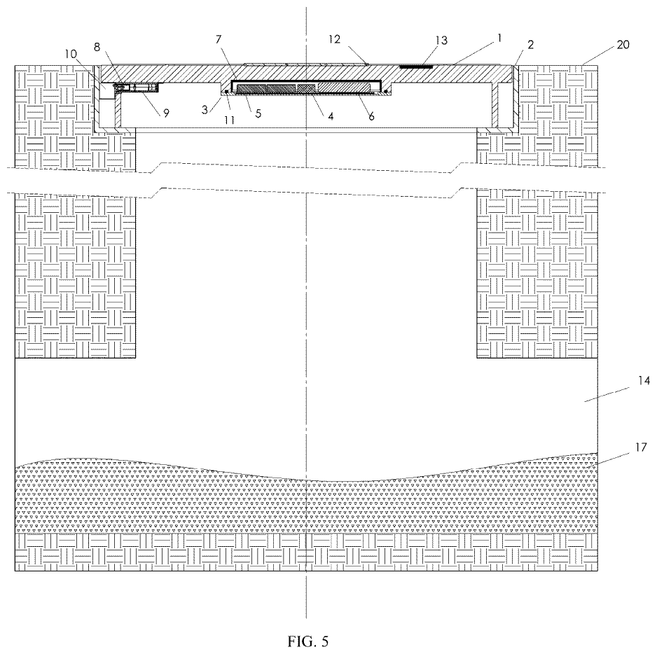

The parts in the figures are numbered individually and the corresponding numbers are given below.
(1) Smart cover unit
(2) Manhole cover housing
(3) Electronic device housing sealed bottom cover
(4) Millimeter (mm) wavelength RADAR module
(5) Electronic control unit
(6) Battery
(7) Electronic device housing
(8) Electrically controlled lock mechanism
(9) Lock box
(10) Keeper
(11) Sealing gasket
(12) Solar energy panel
(13) LPWAN communication antenna socket
(14) Network line whose level is monitored
(15) RADAR module transmitter signal
(16) Low power RF data communication with LPWAN
(17) Flow within the network whose level is monitored
(18) LPWAN data communication network station
(19) Network management actuator connections
(20) Mounting surface
(21) Internet service provider
(22) Central server
(23) Database
(24) Mobile applications and computers for personal service and communication
(25) External object in the monitored fluid line
(26) RADAR signal reflected from the monitored surface
(27) Voltage-regulated supply internal supply line
(28) Voltage regulator
(29) SMPS (Switch mode converter) converter
(30) Battery charge regulator
(31) Wireless charging receiver module
(32) Wireless charging inductive energy transfer
(33) LPWAN type RF transceiver module (NB-IoT, m-IoT etc.)
(34) Wireless mobile charging unit
(35) Optional temperature sensor
(36) Optional motion sensor
(37) Common communication line for reading digitized data
(38) Embedded microprocessor
(39) Bluetooth module
(40) RADAR antenna
(41) Tilt change sensor
(42) Nearest reflection distance in RADAR measurement
(43) Circumferential reflection (second) distance in RADAR measurement
(44) Main level reflection distance in RADAR measurement
(45) Low-pass adaptive digital filter
(46) Noise and disturbance filtered digital signal
(47) Measurement signal editing, linearization and calibration
(48) Calibrated and linearized measurement data
(49) Distortion decomposition by distance spectral distribution extraction
(50) Real RADAR echo surfaces distance distribution
(51) Internal analytical module
(52) Average out-of-level object and event class record on the main surface.
(53) Low-pass digital filter in main surface reverberation
(54) S₁[n]: Variation of level measurement in the first smart cover with respect to time
(55) S₃[n]: Variation of level measurement in the third smart cover with respect to time
(56) S₅[n]: Variation of level measurement in the fifth smart cover with respect to time
(57) Sₚ[n]: Variation of level measurement in “p” th smart cover with respect to time
(58) S₅[n]: Variation of the level measurement in the second smart cover with respect to time
(59) S₄[n]: Variation of the level measurement in the fourth smart cover with respect to time
(60) S₁[n−1]: One sample previous measurement value of the level measurement value S1[n] in the first smart cover
(61) S₁[n−m+1]: “m−1” sample previous measurement value of the level measurement value S₁[n] in the second smart cover,
(62) S₂[n−1]: One sample previous measurement value of the level measurement value S²[n] on the second smart cover,
(63) S₂[n−m+1]: “m−1” sample previous measurement value of the level measurement value S²[n] in the second smart cover,
(64) S₃[n−1]: One sample previous measurement value of the level measurement value S₃[n] on the third smart cover,
(65) S₃[n−m+1]: “m−1” sample previous measurement value of the level measurement value S₃[n] in the third smart cover,
(66) Supervised training data input of a machine learning (ML) system for the prediction of a selected coordinate and event type of monitored network data
(67) Prediction output of monitored network data according to a selected coordinate (x, y) and event type (e)
(68) Value prediction output of the monitored network data for a selected coordinate (x, y) and a selected time (ΔT) according to event type (e)
(69) Artificial intelligence/machine learning (AI/ML) module
(70) Sampling period

### DETAILED DESCRIPTION OF THE EMBODIMENTS

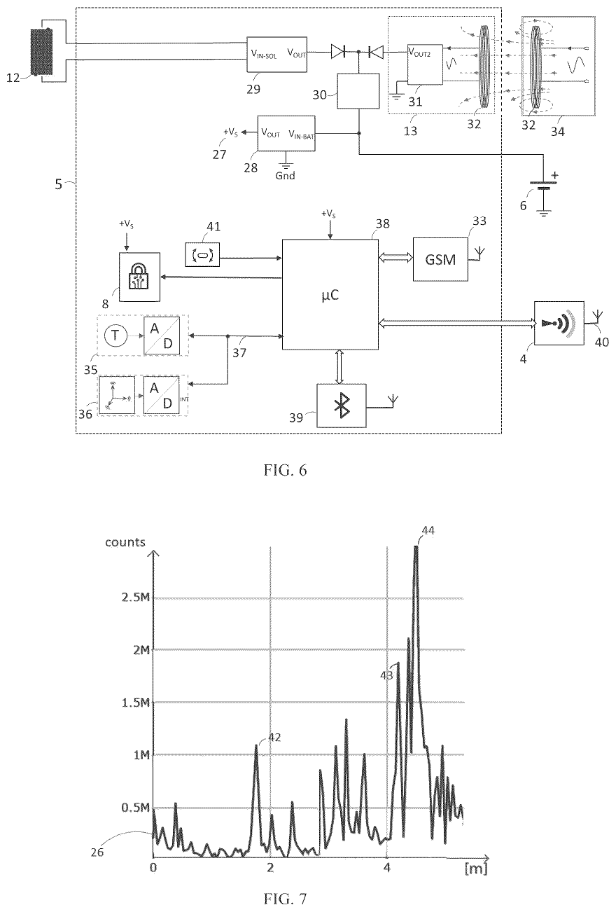

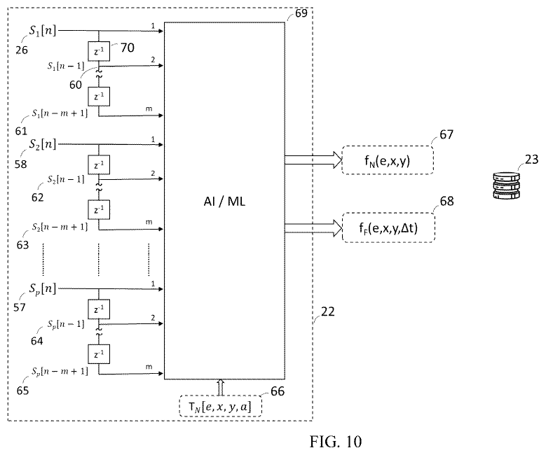

In the inventive device, measurement, pre-treatment, energy management and communication are provided by the smart cover unit (1) integrated into the manhole cover. In addition to event and time triggering, the inventive device can also perform low power RF data communication (16) with the measurement RADAR module transmitter signal (15) LPWAN by being awakened via a radio frequency radio RF communication protocol in an LPWAN standard that supports low power communication such as NB-IoT. It is aimed to provide low power consumption and high reliability with the features described in the inventive system. For long-term maintenance-free operation with low power consumption, an embedded microprocessor (38) with very low power consumption is awakened in standby or sleep modes on an event or rule-based basis, the V-band RADAR antenna (40) is operated intermittently as required, and data is sent over a commercial wide area communication network with very low power consumption with LPWAN type RF transceiver module (33). The other detection, estimation and prediction operations described here (FIG. 10) are performed on the central server (22). The sampling and sending of samples for measurement can be performed under different conditions or periods. For example, multiple conditions can be defined, such as taking a measurement every minute and taking it every 20 minutes or at any time in the communication protocol, allowing optimization between the need and energy consumption. Thus, with an internal battery, uninterrupted data can be sent at the year level without replacement, and even with a small solar energy panel (12), unlimited and completely maintenance-free operation can be achieved. In the invention, if the battery (6) used is selected as a rechargeable type, a wireless mobile charging unit (34) can be connected to provide initial start-up or start-up in a situation where the internal energy drops below a critical level The voltage from the solar panel is brought to the level required to supply the internal electronic system and charge the battery with an SMPS (Switch mode converter) converter (29). In case of wireless charging, this is provided by the wireless charging receiver module (31). The electric current that can come from both sources is combined with the diode circuit (FIG. 6) and the battery is charged by the charge regulator (30) according to the battery characteristics. In case of using non-rechargeable battery such as Alkaline etc. instead of rechargeable battery, there is no need to connect this part. In both cases, the voltage required for the operation of the embedded microprocessor (38), RADAR module (4), LPWAN type RF transceiver module (33) modem, bluetooth module (39) of other peripheral sciences is provided by the voltage regulator (28) on the line connected to the voltage regulated supply internal supply line (27) battery. The embedded microprocessor (38) drives the micro RADAR module (4) with many patch RADAR antennas (40), which operates mainly at V-band frequencies and above. As in the conventional RADAR technique, the RADAR module works by evaluating the part of the transmitted RADAR module transmitter signal (15) and the reflected RADAR signal (26) reflected from the monitored surface in different directions and distances based on latency with signal processing techniques. The signal processing technique used in the present invention uses normalization and pattern recognition based classification features within these echo patterns, so that the sensitivity required for the intended usefulness can be achieved at frequencies in the V-Band and above. The raw count data from the RADAR module, proportional to the echo distance, is in the form of a series of direction-distance distributions for each scan period. (FIG. 7).

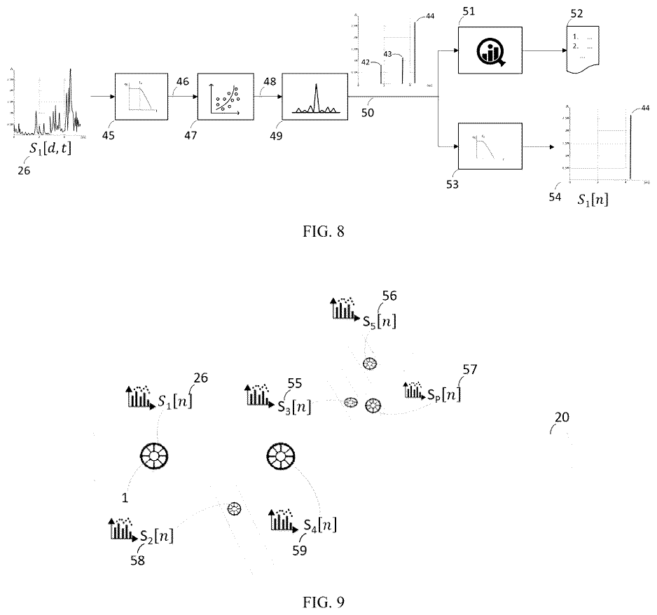

The target level measurement, which is the deepest distance in this incoming data, includes measurements taken from the main surface reflection distance (44) in the RADAR measurement, as well as measurements taken from environmental reflection points at different distances. In RADAR measurements, the peripheral reflection distance (43) is used to classify objects in the vicinity of the level to be measured. For example, in a system that monitors rainwater, if the average depth does not change by more than 5% in 5 minutes on average, while a 20% change in minutes creates a pattern between samples, this can be sized by associating it with a floating object and its passage can be tracked at different points throughout the system. If the past regressional relationship between the level change pattern S₁[n] (54) in an inventive device and others S₂[n] (58), S₄[n] (59) in the same line shows an anomaly, such changes can also be classified and used to diagnose problems such as blockage and leakage On the other hand, the continuous or patterned variation of the nearest reflection distance in the RADAR measurement (42) of echoes in the vicinity of the cover, other than the main level, can also be interpreted. For example, an animal or a person climbing from the inside towards the hatch or a deformation or dent in the hatch hall can be distinguished by pattern analysis. The first level of this analysis is performed in the signal processing process within the inventive device (FIG. 8), while other long time window evaluations are performed by artificial intelligence/machine learning (AI/ML) modules (69) running on the central server (22).

After the smart cover unit (1) is placed in the manhole cover housing (2) like conventional manhole covers, the electronic control unit (5) with the embedded processor is located in an insulated chamber for fully closed operation. The terminal connection of the battery and optional solar energy panel (12) and the control connections of the electrically controlled locking mechanism (8) are also connected with sealed cables through this box. The smart cover unit (1) is made of composite material due to its high strength and electromagnetic permeability. The electronic device housing (7) built into the slot on the underside of the composite cover is sealed with the sealing gasket (11) and the electronic device housing sealed bottom cover (3). The smart cover unit (1) thus becomes an integrated measuring, data processing and communication unit without an external connection. According to the transmittance of the material used in the structure of the manhole cover at the frequencies of the RADAR antenna (40) where the RADAR module (4) of the LPWAN modem operates, if there is a need to increase the gain, RF communication can be provided in the direction of the top of the LPWAN communication antenna socket (13) cover by filling with a different material with less attenuation in communication, without disturbing the full closure condition.

During the initial placement of the smart cover unit (1) in the manhole cover housing (2), the electronically issued unique identification number (Unique ID) and the location of the manhole in the system are matched and stored in the database (23) by a service software on the central server (22) of the mobile application and computers for personal service and communication (24) with authorized access. For this purpose, a mobile phone can be connected to the bluetooth module (39) at the location where it is located and the initialization and pairing security protocol can be operated, or it can be accessed directly via the LPWAN data communication network station (18). In order to be able to perform transactions with access over the LPWAN network, the LPWAN type RF transceiver module (33) in the electronic control unit (5) must have previously registered the subscription information with e-sim or a similar method. The optional electrically controlled lock mechanism (8) on the inventive device can also be controlled from the centre via LPWAN or on-site via an authorized smartphone application, or the status of the on-off tilt change sensor (41) can be monitored. For this purpose, authorizations with different validity on the basis of task, person, place and time can be managed via a central server (22) application Once the device units of the invention are registered in the system, access and management authorizations can be managed in the form of single-use passwords that can be carried with mobile devices in case of network communication problems or special authorizations valid in case of emergencies and disasters. Thus, when the inventive system is used to manage critical infrastructures with security, vulnerability is prevented in the interruption of other infrastructures such as communication, etc. connected for operation with high efficiency in normal time. For this purpose, the system software in the embedded microprocessor (38) in the device module of the invention changes the mode with special codes coming from access via LPWAN or Bluetooth and allows authorization, control and operations specific to disaster and interrupted working conditions. For example, if necessary, a fire brigade unit can open a lock-controlled device in the lock box (9), to which it is not normally authorized to have access, and draw water from the rainwater line.

An important difference that distinguishes the inventive device from common level measurement automation systems is the patterned measurement and evaluation of the signal at each point (FIG. 8) and their processing as a group on a system (FIG. 9). In the part of this operation on the inventive device, the direction coded RADAR echo distance distribution data (FIG. 7) received at each scan period is filtered by a low-pass adaptive digital filter (45). In this way, noises outside the motion target measurement bandwidth are reduced. When the inventive device is first switched on, it can be put into conditioning and calibration mode. Two functions are performed in this mode. The first is normalization and the second is calibration. The incoming distance data is in the form of counts and after the first position, normalization is performed by excluding echoes due to general environmental disturbances from the measurement. For this purpose, a normalization command with authorized access when the device of the invention is plugged in, while there are no unusual object changes in the channel, saves the location of reflections outside the average dip level and excludes them from further processing. For this purpose, the normalization of the static structural values in the off-bottom object-distance discrimination is also performed with the built-in analytical module (51), and the average out-of-level object and event class record on the main surface (52) is passed as an excluded signal. In order to operate the signal processing systems shown in FIG. 8 and FIG. 10 for the inventive device with the desired sensitivity and reliability, it is critical that the internal mm-wavelength RADAR is at frequencies in the V-band and above. Otherwise, the distortion in the scattering profile of the RADAR signal and echo transmitted at lower frequencies may cause a decrease in sensitivity and reliability performance. After the initial commissioning of the system, normalization (exclusion of non-noise but non-main target structural echoes) together with digital filtered distance distribution dataset in distance metres in the form of counts (46), linearization and calibration (47), together with measurements at multiple points (FIG. 10), ensure the consistency required by the group operation (FIG. 10) and thus increase the accuracy of diagnosis, prediction and event classification based on observations on the network (FIG. 9). Two methods can be applied for calibration and linearization. The first one is the two-point calibration technique with the cover open. Accordingly, first the reflectivity at the farthest distance is taken as an offset and the zero point is accepted. When the reflecting surface is at a second physically measured level, the difference with respect to the offset is proportional to the distance in metres and then a known linearization function is selected which characterises the behaviour of the RADAR module for the environment in question. In practice, the required level change with respect to the offset point during calibration can also be achieved by artificially displacing a reflecting surface sufficiently to represent the full physical measurement range. Another calibration and linearization method is to perform a direct multi-point calibration without selecting a known linearization model. Accordingly, the test projection point is moved across the range at different distances and recorded in counts (FIG. 7), which can be in multiples of millions of counts (M) depending on the transducer resolution. Here, the actual distance values corresponding to the test reflecting surface are matched and the intermediate points are connected by a multipoint regression. The calibrated and linearized echo distance distribution (48) is then obtained. Operations other than normalization can generally be carried out in the manufacture of the device according to the invention and do not require modification. The internal analytical module (51) uses independent and discrete real radar echo surface distance distributions (50) obtained by distortion decomposition by distance spectral distribution extraction (49) to decompose the group peaks on the processed distance distribution. The internal analytics module classifies object descriptions outside the main grid as pattern changes over time and transfers them to the average out-of-level object and event class register (52) on the main surface. Thus, at the time of communication, in addition to the bottom level change S₁[n] (54) pattern sample, the object/event and time relations in the object and event class record (52) object/event and time relations in the non-average level object and event class record on this main surface can also be sent.

In the notation here, Si[n] indicates the n. measurement value of the i. smart cover unit. In the case of periodic measurement, the value progressing as n=0, 1, 2 . . . , the measurement at the moments t=nT={0, T, 2T, 3T, . . . } respectively, where T is the sampling period (70), is briefly denoted as Si[n]. Accordingly, Si[n−1] represents the previous measurement value, and if the sampling is periodic, T corresponds to the previous value for the sampling time. Similarly, Si[n−p] denotes the previous measurement of p grains, and if periodic sampling was carried out specifically, t=pT denotes the previous measurement value. The inventive device can also be woken up via bluetooth or LPWAN and can operate on demand. In this case, a number of RADAR distance measurements should be made separately for each wake-up moment as a group, such that the output values of the input digital filters (45), low-pass digital filter in the main surface (53) echo are stable.

The bottom level measurement may fluctuate due to reasons other than the average level of the network line (14) in which it is located, such as the flow rate of the flow in the network whose level is monitored (17) and the external object in the monitored fluid line (25) carried by floating. Changes such as mechanical fluctuations etc. other than other measurement noise can be filtered by a second filter with a lower cut-off frequency (e.g. 0.1 Hz etc.) and the dip level and change can be determined more accurately. Thus, the ripple rate can be determined from the difference between the instantaneous bottom level measurement value after normalization and the average bottom level measurement value at the main surface reflection distance in the radar measurement (44). The ripple ratio can also provide approximate data on the flow rate. Depending on the positioning of the RADAR, the inventive device can provide speed data as well as distance data.

The device data at different points on the mounting surface (20) of a network system (FIG. 9) and their time-varying patterns S₁[n] (54), S₂[n] (58), S₃[n] (55), S₄[n] (59), S₅[n] (56), Sₚ[n] (57) can be used for many different purposes at the central server. A significant group of these, including prediction, anomaly detection, early warning, alarm, predictive maintenance or decision support, are based on machine learning and artificial intelligence applications. For this purpose, machine learning applications running on the central server (22) enter a total of m values, including the current value, as time series into the artificial intelligence/machine learning modules (69), including the current data S₁[n] (54), S₂[n] (58), Sₚ[n] (57), at each measurement point, their sampling period (70) values S₁[n−1] (60), S₂[n−1] (62), S₃[n−1] (64), which are delayed by one period with a unit translator (z−1), and (m−1) delayed values S₃[n−m+1] (65). When a new known event arrives, its coordinate (x, y) or location in the network and event type (e) and its value are applied as a tag value to the supervised data input of the machine learning (ML) system for the prediction of a selected coordinate and event type from the supervised monitored network data (66). In time series forecasting, the new value can also be used as training data for supervised learning before the past values are translated. For machine learning, methods such as deep learning, LSTM, CNN, PECNET can be used with appropriate hyper-parameter selection. Artificial intelligence modules (69) can output (Nowcasting) a prediction of the current event type, location (x, y) or anomaly at the output of the model trained according to the time series at the continuous operation mode or test mode input (67) according to a selected coordinate (x,y) and event type (e) of the monitored network data, as well as a prediction (Forecast) of the values to be taken after a certain ΔT time (68) for a selected time (ΔT) according to a selected coordinate (x,y) and event type (e) of the monitored network data. These prediction values are also transferred to the logger database (23) and can be used for system management by mobile applications and computers for personal service and communication (24) and network management actuator connections (19) via the internet service provider (21).

A very common problem encountered in manhole covers is the detection and prevention of opening by unauthorized persons and the determination of operation times by authorized persons. In the electronic control unit (5) of the inventive device, the optional multi-axis motion sensor (36) determines the movement of the cover in three or one axis, if desired, and transfers the digitized data to the embedded microprocessor (38) for reading the common communication line (37), and in this way, the processor can be awakened from the very low power mode and the relevant control and communication can be provided. Since velocity and displacement can be calculated by taking the integral of acceleration data from the multi-axis motion sensor (36), it can also be used for acceleration determination of collapse, structural change, damage to culvert or manhole, earthquake or explosion. A tilt sensor (41), either independently or in combination with a multi-axis motion sensor, can also be used directly to the embedded microprocessor (38) to provide a logical motion indication and interrupt for fast wake-up.

Monitoring the temperature distribution and temporal variation patterns in urban waste or service networks, together with the level and movement in the channels, can provide important information for maintenance and operation. For this purpose, in the inventive device, the internal temperature sensor (35) can be read by the embedded microprocessor (38) via the common communication line for reading common digitized data (37). Internal-external temperature differences can be used to detect conditions such as blockage in the manhole cover, gas accumulation inside, excessive rise in the level, increase in organic matter in the channel, fire or increase in the mounting surface (20) temperature-internal temperature difference due to decrease in the external temperature. Contextual changes in the temperature sensor (35) according to the operating state of the electronic control unit (5) are also utilized for the automatic diagnosis of internal electronic component or system problems.

1. A smart manhole cover, comprising:
a radar level meter; and
wherein low-power RF data communication with low-power wide-area-network (LPWAN) provides access to a standard network station of the LPWAN type, in particular the NB-IoT standard, with a sensitive RADAR module at frequencies in the V-band and above, and a low-power RF data communication RF transceiver module of the RF modem of the LPWAN type integrated with a low-power signal processing unit with a built-in battery in an electromagnetically permeable composite smart cover unit, to commission of mobile applications and computers for personal services and communication by matching the production identification number with the location code installed in a closed and sealed plug&play manner, to take the internal analytical module out of monitoring by normalizing the disturbing echoes from non-monitoring environmental and structural objects by recording them at the nearest reflection distance and patterns of variation of the target level measurement with respect to time S₁[n], with adjustable sampling period, sends measurement data to the database to the central server with very low power consumption, without requiring battery replacement for periods in the order of years or without an external energy source connection, by means of the microprocessor wake-up recording S₁[n], S₁[n−1], S₁[n−m+1] during measurement-processing and communication times by means of one of the event triggered or polling over the network methods.

2. The smart manhole cover as in claim 1, wherein when a solar energy panel integrated on the smart cover unit is used, a rechargeable type internal battery is used and is charged by internal voltage regulators.

3. The smart manhole cover as in claim 1, wherein a processor electronic control unit and the embedded microprocessor are activated by transferring non-contact energy via wireless charging energy transfer with a wireless mobile charging unit when there is no energy left in the internal battery.

4. The smart manhole cover with a radar level meter as in claim 1, wherein the temporal patterns S₁[n], S₁[n−1], S₁[n−m+1], S₂[n], S₂[n−1], S₂[n−m+1], Sₚ[n], S₃[n−1], S₃[n−m+1] are evaluated on a central server by extracting the ones other than those selected as the closest reflection distance in the radar measurement as structural or environmental disturbances in the distance pattern from the RADAR module, and are used for S₁[n], S₂[n], S₃[n], S₄[n], S₅[n], Sₚ[n] machine learning based object and event detection at multiple points of an assembly surface and future value prediction such as flood, flood or failure risk.

5. The smart manhole cover with a radar level meter as in claim 1, wherein the level radar measurement with the temperature sensor determines the temperature rise due to fire, organic matter change or internal malfunction in the channel together with main surface reflection distance data.

6. The smart manhole cover with a radar level meter as in claim 1, further configured to transmit data to a central server system for determining deformations during and after possible events, the shaking intensity and impact distributions in case of earthquakes, with velocity and displacement values obtained from acceleration and integral values by the embedded microprocessor, together with level changes with a multi-axis motion sensor, or retrospective point data is collected with a mobile device via a local bluetooth module connection.

7. The smart manhole cover as in claim 1, wherein the embedded microprocessor is awakened by a tilt change sensor, the opening and closing times of the cover are recorded and transmitted to the central server during communication periods.

8. The smart manhole cover with a radar level meter as in claim 1, wherein the RADAR antenna determines the speed of vehicles or pedestrians passing over the mounting surface, with or without internal level change, by using multiple radar modules up, down or in both directions.

9. The smart manhole cover with a radar level meter as in claim 1, wherein main surface reflection distance in the level radar measurement by processing RADAR distance distribution and surface ripple and feed rate is determined from the long and short time period change differences in the internal signal processing system.

10. A smart manhole cover, comprising:
a radar level meter,
wherein the central embedded microprocessor verifies the password transferred via smartphone or tablet according to one-time or place-duration related authorizations on an application that communicates with the bluetooth module, and verifies the manhole cover electrically controlled lock mechanism with a predetermined algorithm or central communication and record and transfer the opening-closing status and alarm conditions by controlling the keeper and determining the authorized or unauthorized opening status with the multi-axis motion sensor as integrated with low-power RF data communication with LPWAN enabling access to a standard LPWAN data communication network station of the LPWAN type, in particular the NB-IoT standard, integrated in an electromagnetically permeable composite smart cover unit of the LPWAN type RF transceiver module with a signal processing unit powered by an internal battery.
